(19) United States
(12) Patent Application Publication
(10) Pub. No.: US 2016/0073479 A1
(43) Pub. Date: Mar. 10, 2016

(54) MODULAR ILLUMINATION DEVICE AND ASSOCIATED SYSTEMS AND METHODS

(71) Applicant: BeON HOME INC., Cambridge, MA (US)

(72) Inventors: Alexei A. Erchak, Cambridge, MA (US); Arvind S. Baliga, Lexington, MA (US); Martin Forest, Arlington, MA (US); Michael Denninger, Bedford, MA (US)

(73) Assignee: BeON Home Inc., Cambridge, MA (US)

(21) Appl. No.: 14/888,230

(22) PCT Filed: May 1, 2014
(86) PCT No.: PCT/US2014/036307

§ 371 Date: Oct. 30, 2015

Related U.S. Application Data
(60) Provisional application No. 61/918,430, filed on Dec. 19, 2013.
(60) Provisional application No. 61/886,446, filed on Oct. 3, 2013.
(60) Provisional application No. 61/818,374, filed on May 1, 2013.

(51) Int. Cl. H05B 37/02; H05B 33/08; F21V 23/00; F21K 99/00; F21V 23/04

(52) U.S. Cl. CPC H05B 37/0245; F21K 9/135; F21V 23/0435; F21V 23/009; H05B 37/0272; H05B 33/0842; F21Y 2101/02

(57) ABSTRACT

A modular illumination device, and associated systems and methods, are provided. In some cases, a hub is provided. The hub can, optionally, be configured to receive at least one module via an interface. The hub can comprise an optional fitting configured to be mounted in a light socket, an optional networking component, and/or an optional illumination source. In some cases, the hub can be coupled to a module such that an external surface of the module occupies a relatively large percentage of the external surface area of the coupled hub and module and/or such that a substantially smooth surface is formed between the hub and module. In some cases, the hub can be coupled to a module having a relatively large volume. Also disclosed are covers configured to at least partially enclose wall-mounted electric switches, systems for retrofitting electric switches, and methods of retrofitting electric switches.

### RELATED APPLICATIONS

This application claims priority under 35 U.S.C. §119(e) to U.S. Provisional Patent Application Ser. No. 61/818,374, filed May 1, 2013, and entitled “Modular Illumination Device and Associated Systems and Methods”; U.S. Provisional Patent Application Ser. No. 61/886,446, filed Oct. 3, 2013, and entitled “Modular Illumination Device and Associated Systems and Methods”; and U.S. Provisional Patent Application Ser. No. 61/918,430, filed Dec. 19, 2013, and entitled “Modular Illumination Device and Associated Systems and Methods”; each of which is incorporated herein by reference in its entirety for all purposes.

### TECHNICAL FIELD

Devices configured to provide illumination and/or configured to be mounted in a light socket are generally described.

### SUMMARY

Articles, systems, and methods related to illumination devices are generally described. Certain embodiments are directed to a modular devices comprising a hub, which can be configured to be coupled to at least one module and/or communication interfaces (e.g., between the hub and a module(s) and/or between multiple modules). The modular device may be configured, according to certain embodiments, to provide illumination and/or to be mounted in a light socket. The subject matter of the present invention involves, in some cases, interrelated products, alternative solutions to a particular problem, and/or a plurality of different uses of one or more systems and/or articles.

According to certain embodiments, a hub is provided. The hub comprises, in some embodiments, a fitting configured to be mounted in a light socket, and a networking component, wherein the hub is configured to receive at least one module via an interface.

The hub comprises, according to certain embodiments, a fitting configured to be mounted in a light socket, wherein the hub is configured to receive at least one module via an interface such that the hub and module can be coupled to form a unitary body having an external surface area, and wherein an external surface of the module occupies at least about 5% of the external surface area of the unitary body when the hub and he module are coupled.

In some embodiments, the hub comprises a fitting configured to be mounted in a light socket, wherein the hub is configured to receive at least one module via an interface such that the hub and module can be coupled to form a unitary body having a substantially smooth surface formed between the hub and the module.

The hub comprises, in some embodiments, a fitting configured to be mounted in a light socket, wherein the hub is configured to receive at least one module having a volume of at least about 13 cm³ via an interface such that the hub and module can be coupled to form a unitary body.

In certain embodiments, the hub comprises an illumination source configured to emit light at a luminous flux of at least about 375 lumens; and a networking component, wherein the hub is configured to receive at least one module via an interface.

The hub comprises, according to some embodiments, an illumination source configured to emit light at a luminous flux of at least about 375 lumens, wherein the hub is configured to receive at least one module via an interface such that the hub and module can be coupled to form a unitary body having an external surface area, and wherein an external surface of the module occupies at least about 5% of the external surface area of the unitary body when the hub and he module are coupled.

In some embodiments, the hub comprises an illumination source configured to emit light at a luminous flux of at least about 375 lumens, wherein the hub is configured to receive at least one module via an interface such that the hub and module can be coupled to form a unitary body having a substantially smooth surface formed between the hub and the module.

In certain embodiments, the hub comprises an illumination source configured to emit light at a luminous flux of at least about 375 lumens, wherein the hub is configured to receive at least one module having a volume of at least about 13 cm³ via an interface such that the hub and module can be coupled to form a unitary body.

Certain aspects are related to a system. The system comprises, in some embodiments, a hub comprising a fitting configured to be mounted in a light socket and a networking component; and a module coupled to the hub via an interface.

In some embodiments, the system comprises a hub comprising a fitting configured to be mounted in a light socket; and a module coupled to the hub via an interface to form a unitary body having an external surface area, wherein an external surface of the module occupies at least about 5% of the external surface area of the unitary body.

According to some embodiments, the system comprises a hub comprising a fitting configured to be mounted in a light socket; and a module coupled to the hub via an interface to form a unitary body having a substantially smooth surface formed between the hub and the module.

The system comprises, in some embodiments, a hub comprising a fitting configured to be mounted in a light socket; and a module having a volume of at least about 13 cm³ coupled to the hub via an interface to form a unitary body.

The system comprises, according to certain embodiments, a hub comprising an illumination source configured to emit light at a luminous flux of at least about 375 lumens and a networking component; and a module coupled to the hub via an interface.

According to certain embodiments, the system comprises a hub comprising an illumination source configured to emit light at a luminous flux of at least about 375 lumens; and a module coupled to the hub via an interface to form a unitary body having an external surface area, wherein an external surface of the module occupies at least about 5% of the external surface area of the unitary body.

In some embodiments, the system comprises a hub comprising an illumination source configured to emit light at a luminous flux of at least about 375 lumens; and a module coupled to the hub via an interface to form a unitary body having a substantially smooth surface formed between the hub and the module.

In certain embodiments, the system comprises a hub comprising an illumination source configured to emit light at a luminous flux of at least about 375 lumens; and a module having a volume of at least about 13 cm³ coupled to the hub via an interface to form a unitary body.

Certain aspects are related to a cover configured to at least partially enclose a wall-mounted electric switch. In some embodiments, the cover is configured such that, when the cover is placed over the wall-mounted electric switch, the state of the wall-mounted electric switch is fixed in an on position, wherein the cover comprises a wireless switch configured to switch a light-emitting element between an on state and an off state.

Some embodiments are related to a system for retrofitting an electric switch. The system comprises, in some embodiments, a cover at least partially enclosing a wall-mounted switch that controls power supplied to a fixture via an electric circuit, the cover fixing the state of the wall-mounted switch in an on position; and a wireless switch in communication with a light-emitting element receiving power from the electric circuit within which the wall-mounted switch is positioned, the wireless switch configured to switch the light-emitting element between an on state and an off state.

Some embodiments are related to a method of retrofitting an electric switch. In some embodiments, the method comprises fixing a state of a wall-mounted switch within an electric circuit to an on position; and switching a light-emitting element receiving power from the electric circuit between an on state and an off state using a wireless switch in communication with the light-emitting element.

In some embodiments, the modular illumination device comprises a hub configured to receive at least one module via an interface.

In any of these embodiments, the hub may optionally comprise at least one connection configured to send an electrical signal to and/or receive an electrical signal from the module.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1A is a perspective view schematic illustration of an exemplary hub connected to modules, according to some embodiments;

FIGS. 1B-1C are perspective view schematic illustrations of an exemplary module, according to certain embodiments;

FIG. 2 is an exemplary perspective view schematic illustration illustrating the connectivity between a hub and modules;

FIGS. 3A-3C are, according to certain embodiments, schematic illustrations of an exemplary illumination device;

FIG. 4 is a schematic block diagram of an exemplary light control panel, according to some embodiments;

FIG. 5 is, according to certain embodiments, a block diagram of an exemplary emergency illumination device;

FIGS. 6A-6F are schematic illustrations showing a cover configured to maintain a switch in an “on” position, according to some embodiments; and

FIG. 7 is a table illustrating a variety of fittings configured to be mounted in light sockets, suitable for use in various of the embodiments described herein.

### DETAILED DESCRIPTION

A modular device comprising a hub, optionally one or more modules, and interfaces between the hub and the modules is generally described. Hubs configured for use in such devices, and associated systems, are also described. In certain embodiments, the hub comprises an illumination source. The hub may, according to some embodiments, comprise a fitting configured to be mounted in a light socket. In this way, the hub may be used as a replacement for a convention light bulb.

Certain embodiments relate to systems comprising a hub and a module coupled to the hub via an interface. The module and the hub can form a unitary body. In some such embodiments, the module can be relatively large and/or occupy a relatively large percentage of the external surface area of the unitary body. Using such relatively large modules can, according to certain embodiments, make removing and/or replacing the modules relatively easy.

Methods for retrofitting electric switches are also provided. Certain of the inventive methods described herein can allow one to use an existing switch to continuously provide power to a light socket while also providing the ability to switch an illumination source connected to the light socket on and off, without the need for rewiring the existing switch. This can make installation of various of the systems and devices described herein relatively easy, as existing switches can be used with little modification.

The systems and articles described herein can be used to perform a variety of functions. For example, the hub provides, in certain embodiments, at least one function including but not limited to illumination, networking, power, thermal management, sensing, processing, and/or intelligence. In some embodiments, the hub provides mechanical structure for the illumination device and/or a physical interface with the lighting electrical power infrastructure. The module(s) can be configured to provide functionality including but not limited to power, sensors, audio, visual, security, networking, and/or interfaces with remote devices (e.g. peripherals). Modules can be configured to provide a variety of types of functionality. For example, modules can be configured to provide one and/or more of: safety features such as smoke detection, carbon monoxide detection, emergency backup lighting and/or audio alarm; comfort features such as temperature measurement and/or control, humidity measurement and/or control, and/or measurement and/or control of other measures of air quality; audio/visual functionality, for example, via speakers, microphones, cameras, and/or projection display systems; security features such as video monitoring (e.g., using cameras), baby monitoring, surveillance monitoring, and/or visual and/or audio alarms; and/or healthcare features such as patient monitoring. It is also envisioned that, in certain embodiments, information collected by and/or provided by the hub and/or the individual modules is accessible remotely (for example, via a remote network) using any suitable access device (e.g., remote accessibility from a mobile phone, a laptop computer, a desktop computer, a tablet, a television set-top box, a gaming console, a standalone networked controller unit, and/or via any other suitable device). In some embodiments, a mobile phone may provide the primary control interface for the modular illumination device. Other control interfaces are also envisioned such as, for example, any of the remote access devices previously mentioned in this paragraph. In certain embodiments, the module(s) can be configured to provide entertainment functionality. For example, the module(s) can be configured to provide sound, internet relay (e.g., a WiFi repeater), video (e.g., via a camera), or the like. In certain embodiments, the module(s) can be configured to provide other functionality. For example, the module(s) can be configured to provide doorbell functionality, a power outage alert, and/or a smoke alarm alert.

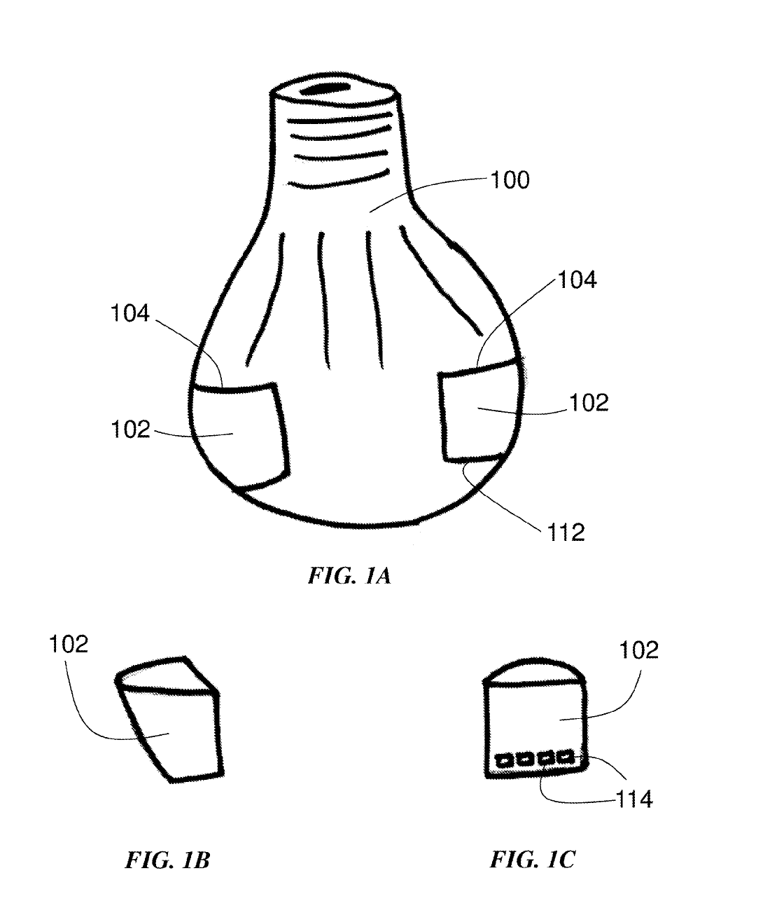

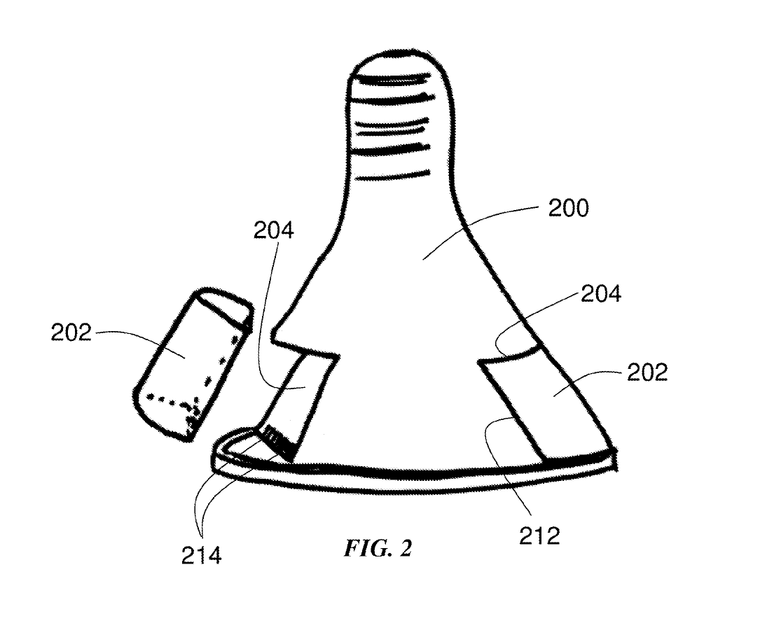

Certain embodiments are related to a hub. The hub may be, according to certain embodiments, configured to receive at least one module via an interface of the hub. FIG. 1A is a schematic illustration of an exemplary hub 100, which is configured to receive modules 102 via interface 104. While hub 100 in FIG. 1A is illustrated as receiving two hubs, it should be understood that the hubs described herein may be configured to receive any number of modules (e.g., a single module, two modules, and/or more than two modules). Modules are described in more detail below.

According to certain embodiments, the hub and the module can be coupled to form a unitary body having an external surface area, as described in more detail below.

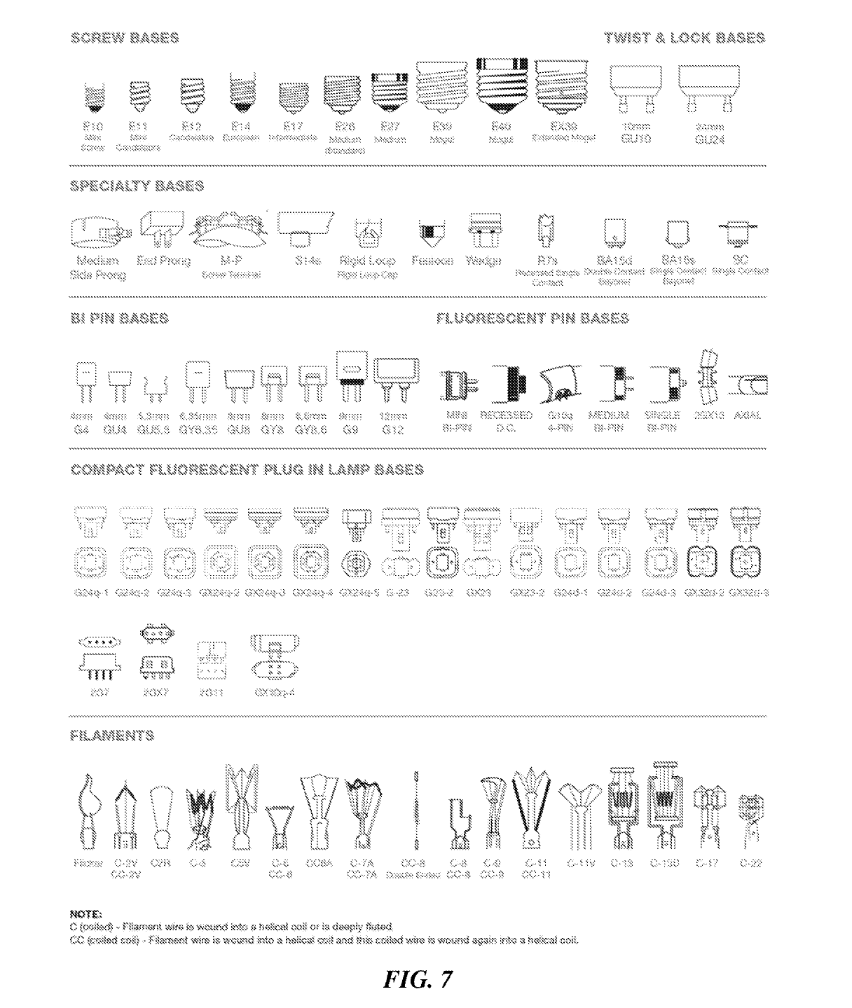

In some embodiments, the modular illumination device is configured to connect to the existing sockets (e.g., ceiling-mounted light sockets) of existing lighting electrical infrastructure. This can be achieved, for example, by including on the hub a physical interface that is identical or similar to the physical interface included in the existing socket. In some embodiments, the hub comprises a fitting configured to be mounted in a light socket (e.g., an Edison socket). For example, in certain embodiments, the hub comprises a threaded surface configured to interface with an Edison socket. Examples of such connections include, but are not limited to, E26 connections, E27 connections, and the like. In certain embodiments, the hub comprises a screw-type fitting (e.g., an E10 (“mini screw”) fitting, E11 (“mini candelabra”) fitting, E12 (“candelabra”) fitting, E14 (“European”) fitting, E17 (“Intermediate”) fitting, E26 fitting, E27 fitting, E39 fitting, E40 fitting, EX39 fitting, and the like), a twist and lock fitting (e.g., a GU10 fitting, GU24 fitting, and the like), a bayonet style fitting (e.g., a B15 fitting, a B22 fitting, and the like), a BI pin type fitting, a fluorescent pin type fitting, a compact fluorescent type fitting, or a filament type fitting. Specific examples of fitting types that may be used are shown, for example, in FIG. 7.

In some embodiments, the light socket to which the fitting on the hub is configured to be mounted comprises at least one of a thread-type socket (e.g., a socket configured to receive an E10 (“mini screw”) connection, E11 (“mini candelabra”) connection, E12 (“candelabra”) connection, E14 (“European”) connection, E17 (“Intermediate”) connection, E26 connection, E27 connection, E39 connection, E40 connection, EX39 connection, and the like), a twist and lock socket (e.g., a socket configured to receive a twist and lock base, such as a GU10 connection, GU24 connection, and the like), a BI pin type socket, a fluorescent pin type socket, a compact fluorescent type socket, a bayonet style socket, or a filament type socket.

In some embodiments the hub aesthetic design closely resembles the aesthetic design of conventional light bulbs such as recessed lighting bulbs (e.g., PAR 20, PAR 30, PAR 38 bulbs, etc.) or general service bulbs (e.g., incandescent Type A bulbs that may be used for example in table or floor lamps). In certain embodiments, the form factor of the illumination device can correspond to a standard ANSI configuration, such as an A-series light bulb (e.g., A19) form factor, or the like. In some embodiments, the hub and/or the combination of the hub and module(s) is in the shape of an A series light bulb (e.g., A-15, A-19, A-21, A-23, and the like), a B series light bulb (e.g., B-8, B-10, and the like), a C-7/F series light bulb (e.g., C-7, C-9, C-11, C-15, and the like), a CA series light bulb (e.g., CA-8, CA-10, and the like), an S series light bulb (e.g., S-6, S-8, 5-11, S-14, and the like), an F series light bulb (e.g., F-10, F-15, F-20, and the like), an RP series light bulb (e.g., RP-11 and the like), an MB series light bulb (e.g., MB-19 and the like), a BT series light bulb (e.g., BT-15 and the like), an R series light bulb (e.g., R-12, R-14, R-16, R-20, R-25, R-30, R-40, and the like), an MR series light bulb (e.g., MR-8, MR-11, MR-16, MR-20, and the like), a PS series light bulb (E.g., PS-25, PS-30, PS-35, and the like), an AR series light bulb (e.g., AR-70, AR-111, and the like), an ALR series light bulb (e.g., ALR-37, ALR-56, and the like), a BR series light bulb (e.g., BR-25, BR-30, BR-38, BR-40, and the like), a PAR series light bulb (e.g., PAR-16, PAR-20, PAR-305, PAR-30L, PAR-36, PAR-38, PAR-46, PAR-56, PAR-64, and the like), a Linestra-type bulb (e.g., T-10 2-base, T6½, T-8, T, JCD, JC, T-tungsten halogen double ended, and the like), a T series light bulb (e.g., T-4, T-4½, T-5½, T-6, T-6½, T-7, T-8, T-10, and the like), a G series light bulb (e.g., G-16½, G-25, G-30, G40, and the like), a BT series light bulb (e.g., BT-28, BT-37, BT-56, and the like), an E series light bulb (e.g., E-17, E-18, E-231/2, E-23, E-37, E-25, and the like), and/or an ED series light bulb (e.g., ED-17, ED-18, ED-23½, ED-28, and the like). However, new aesthetic designs may also be used, for example, because of the new degrees of freedom created by the modular light-bulb design.

According to certain embodiments, the hub comprises an illumination source (which is also sometimes referred to herein as a “light source” or an “illumination light source”). In some embodiments, the illumination source of the hub is configured to emit at a luminous flux of at least about 375 lumens, at least about 450 lumens, at least about 600 lumens, or at least about 800 lumens (and/or, in some embodiments, up to about 2000 lumens, up to about 3000 lumens, up to about 6200 lumens, or more). The illumination source may be used, for example, in a general lighting application. For example, in certain embodiments, the hub and illumination source may be used to replace a traditional light bulb.

Any suitable light source can be used in association with the systems described herein. The light source can be a directional or an omnidirectional light source. In certain embodiments, the light source is positioned near a tip of the hub. For example, the light source can be positioned, in some embodiments, near the top portion of the hub and/or the unitary body formed by the hub and any modules connected to the hub. In some embodiments, one or more light sources can be positioned on one or more side portions of the hub and/or the unitary body formed by the hub and any modules connected to the hub (in addition to or in place of a light source positioned near a tip of the hub and/or the unitary body formed by the hub).

According to certain embodiments, the illumination source and the hub are integrally connected. For example, in some embodiments, the hub and the illumination source can be assembled such that removal of the illumination source requires separate steps of removing of the outer casing of the hub and removing the illumination source.

In many embodiments, the illumination light source for the hub comprises one or more light-emitting diodes (LEDs). The use of a solid-state lighting component (such as an LED) in association with the hub can allow one to more easily integrate the hub with other solid-state components (e.g., sensors or any of the other solid-state components described herein). However, the illumination devices described herein are not limited to those comprising an LED, and in certain embodiments, other, non-LED light sources can be used to provide the illumination function. In some cases, the use of non-solid-state light sources can potentially lead to a reduced amount of module functionality due the relatively high operating temperatures of many such light sources (e.g. incandescent, HID, fluorescent), although the illumination devices described herein are still usable with such sources.

A single illumination light source or more than one illumination light source can be used in association with the hub. In certain embodiments, a plurality of illumination light sources are used to create a light pattern (e.g., a specified beam pattern).

In some embodiments in which the hub comprises LED illumination source capabilities, additional electronics are envisioned such as a metal-core printed circuit board (MCPCB), driver, and/or controller electronics.

According to some embodiments, the hub comprises a networking component. The hub and the networking component can be configured to be part of the same integral unit, according to certain embodiments. For example, in some embodiments, the hub and the networking component can be assembled such that removal of the networking component requires separate steps of removing of the outer casing of the hub and removing the networking component.

Any suitable networking component may be used in association with the hub. In some embodiments, the networking component comprises a wireless networking device. In certain embodiments in which the hub comprises networking functionality, the hub may use various devices, components, and standards such as, for example, WiFi, ZigBee, Bluetooth, Z-Wave, ANT+, an infrared signal, an ISM radio band, and/or ultrasound. In certain embodiments, the hub may contain a single chip transceiver.

According to certain embodiments, the networking component of the hub is configured to communicate with a remote controller unit. For example, in some embodiments, the networking component of the hub can be configured to communicate with a portable electronic device such as a cell phone. In one particular embodiments, an application (also sometimes referred to as an “app”) of a cell phone or other portable electronic device can be configured such that the device can communicate with the networking component of the hub. In some embodiments, the networking component can be configured to communication with other hubs and/or modules associated with (e.g., connected to) other hubs. The networking component may be configured to communicate with multiple devices (e.g., more than one of a remote controller unit, another hub, and/or a module associated with another hub).

In certain embodiments, the hub comprises at least one power source, such as a battery. In some embodiments, the hub contains a backup power supply that provides certain functionality (e.g. air flow for monitoring air quality). In some such embodiments, this can allow operation even when the illumination source is not being powered by the primary electrical socket (e.g., during a power outage or any other situation in which primary power has been disconnected from the hub).

The hub can comprise, according to certain embodiments, a thermal management system. For example, in certain embodiments, the hub contains a heat sink, which can be configured to perform thermal management. The heat sink can be included to cool the hub (and/or modules and/or interfaces in certain instances in which the modules and/or interfaces are in thermal communication with the hub). In this way, the heat transfer area can be used to dissipate waste heat from the light source and/or modules. The heat transfer area may be positioned along any exterior part of the illumination device that is suitable for heat convection and/or radiation to the surrounding environment (e.g., air and/or surfaces in contact with the heat transfer area). The thermal management can be useful for maintaining reliable operation of the illumination device. Active and/or passive cooling systems can be used with certain embodiments. For example, certain embodiments may employ a passive cooling system, which may include extruded fins (e.g., metal fins such as aluminum fins) that transfer heat from the bulb to the outer ambient environment. In some embodiments, a passive cooling system comprising a system of connected heat pipes can be employed. Some embodiments employ an active cooling system, which may include, for example, a fan, a liquid-based cooling system, or any other suitable cooling systems such as the cooler manufactured by Nuventix, Inc.

The hub comprises, according to some embodiments, at least one sensor. As described below, the hub may comprise any one or more of a variety of sensors. For example, the hub comprises, according to certain embodiments, a smoke sensor, a carbon monoxide sensor, a light sensor (e.g., a daylight sensor), an occupancy sensor, a sound sensor (e.g., to detect alarms and/or voice commands), a video sensor (e.g., as part of a security video detection system), and/or any other sensor described herein, alone or in combination with each other, and present as a single sensor or multiple sensors.

In some embodiments, the hub comprises a motion or occupancy sensor that activates the illumination source when motion is detected. The hub may contain, in certain embodiments, a light sensor configured to reduce the amount of light output by the illumination device when ambient light (e.g., daylight) is detected.

According to certain embodiments, the hub comprises at least one processor, such as a microprocessor. In some embodiments, processing and intelligence functionality is envisioned in the hub with integrated circuits (ICs). The ICs may comprise for example of field-programmable gate-arrays (FPGAs) application-specific ICs (ASICs), other ICs, or combination of the aforementioned ICs. In some embodiments, the processor can be constructed and arranged to perform one or more calculations the result of which may be used to change a property or state of operation of the hub and/or of a system including a hub. In some cases, memory may be used in association with the processor. Various embodiments according to the invention may be implemented on one or more computer systems. Suitable processors for use in various of the embodiments described herein include, but are not limited to, those made by ARM, Texas Instruments, Atmel, Intel, Advanced Micro Devices (AMD), Motorola, Qualcomm, Oracle, IBM, Samsung, and the like. In certain embodiments, various of the embodiments described herein can be implemented using a system on a chip (SOC), which may include, for example, a microprocessor, memory, peripherals, and/or low power wireless radio (e.g., Bluetooth smart). Examples of suitable commercially available SOC systems that can be used include, but are not limited, to those manufactured by Texas Instruments (e.g., CC2541) and Nordic Semiconductor (e.g., nRF51822).

Certain embodiments relate to a module, which can be configured to be attached to the hub (e.g., at an interface between the hub and the module). In addition, some embodiments relate to systems comprising a hub and a module coupled to the hub via an interface. FIG. 1A is an exemplary schematic illustration in which hub 100 is attached to modules 102. FIGS. 1B and 1C are exemplary schematic illustrations of module 102.

In some embodiments, the module has a relatively large volume. For example, in certain embodiments, the hub occupies a volume of at least about 13 cm³, at least about 20 cm³, or at least about 25 cm³ (and/or, in some embodiments, up to about 60 cm³, or more). The use of modules with relatively large volumes can be advantageous, according to certain embodiments, as such modules can be easier to handle. For example, relatively large modules may be easier to pick up, add to hubs, and/or remove from hubs.

Various of the modules described herein may be configured to be coupled to a hub at an interface. For example, in FIG. 1A, modules 102 are coupled to hub 100 via interfaces 104. In FIG. 2, for example, modules 202 can be coupled to hub 200 via interfaces 204. The hub and module may be coupled to form a unitary body, in some embodiments, as described in more detail below.

A module can be configured to perform one or more functions, as described in more detail below.

The module can comprise, according to some embodiments, at least one power source. For example, in certain embodiments, the module comprises a power supply. The power supply may be, but is not limited to, a battery (e.g., primary and/or secondary batteries including, for example, an alkaline battery, a rechargeable lithium ion battery, and the like) or any other suitable power supply. Rechargeable and/or non-rechargeable batteries may be employed in certain of the modules described herein. The battery (or batteries) may be used, for example, for powering lights and/or modules. The use of one or more batteries to power lights and/or modules can be useful, for example, when the illumination device is not receiving power from (e.g., is not connected to) an external power source.

It should be understood that the modules described herein do not necessarily include a power source, and that in some embodiments, the module does not contain a power source.

In some embodiments, the module comprises a sensor. The sensor may be in the form of a smoke alarm such as a photoelectric smoke alarm or an ionization smoke alarm. Other examples of sensors suitable for use in certain of the modules described herein include, but are not limited to, sensors configured to monitor temperature, humidity, the presence and/or concentration of particulates, the presence and/or concentration of gases (e.g. toxic gases), sound, imaging, occupancy, and light.

The module can comprise, according to some embodiments, at least one audio device, such as a speaker. The audio device can be used to perform any suitable function, such as to play music, to sounds an alarm, to sound a doorbell, or any other function.

In certain embodiments, the module comprises at least one video device, such as a video camera. The video device may be used, for example, to record video, to provide surveillance of a particular area, or for any other suitable purpose.

In some embodiments, the module comprises a security device. In certain embodiments, the module can be configured to be used as part of a security system. For example, certain of the modules described herein may include cameras, speakers, and/or alarms. The security device may include, for example, one or more sensing devices in the module and/or hub. The sensing device may, for example, communicate information to a property owner, a security company, and/or local authorities.

In some embodiments, the module comprises a sound sensor (e.g., a microphone). The module may be, according to certain embodiments, configured (e.g., programmed) to detect specific sounds (e.g., a security siren, glass breakage, a sump pump alarm, and/or a smoke and/or CO detector alarm). In some embodiments, the module can be configured (e.g., programmed) to detect a custom sound (e.g., a crying baby, a barking dog, and/or customized alarms and/or chimes).

In some embodiments, a module can comprise a networking device which can provide networking capabilities. The networking device of a module can be a wireless networking device, in certain embodiments. For example, certain modules include devices for transmitting signals, for example, via WiFi, Bluetooth, ZigBee, Z-Wave, ANT+, an infrared signal, an ISM radio band, ultrasound, and/or EnOcean standards and protocols. In some embodiments, the module comprises a wireless node, for example, to connect to a home wireless network (e.g., WiFi, Bluetooth, ZigBee, Z-Wave, and the like). The wireless node may be configured, according to some embodiments, to communicate with other devices in the home and/or with other actuators configured to control the bulb. In some embodiments in which the wireless network is connected to the Internet, the module can be configured to be controlled from outside the home (e.g., via a smart phone, PC terminal, and the like). In some embodiments, the module comprises a wireless home network range extender (e.g., WiFi repeater).

In certain embodiments, the module comprises at least one interface configured to communicate with remote devices. For example, in some embodiments, the networking modules can be used to communicate between hubs or with a control interface (e.g. a mobile phone, a television remote control, a light remote control, and/or a smart watch).

In certain embodiments, a module may provide an interface for remote peripherals. Some examples of such remote peripherals include, but are not limited to, devices that notify users of appliances (e.g., an oven) left in the “on” position, a wireless doorbell, lost-item locators, and/or security devices.

In some embodiments, a module may contain a power source for supplying power for at least one module (e.g., the module in which the power source is housed and/or another module). In some such embodiments, the power source associated with the module also supplies power to the hub (e.g., during a power outage).

As noted above, certain embodiments relate to systems comprising a hub, and a module (and/or multiple modules) coupled to the hub via an interface. In some embodiments, a module (and/or multiple modules) is connected to the hub through a physical interface. The interface may comprise, for example, an indentation, protrusion (e.g., a ridge, etc.), or another feature on the hub with which the module or a feature on the module (e.g., an indentation, protrusion, or other feature) mates. In some embodiments, the feature (e.g., an indentation, protrusion, or other feature) of the hub with which the module mates is included on the external surface of the hub. Designing some such embodiments in this manner can allow one to remove a module from a hub and/or add a module to a hub relatively easily (e.g., without disassembling or otherwise compromising the external surface of the hub).

FIG. 2 is a schematic illustration showing the connectivity between a hub 200 and modules 202.

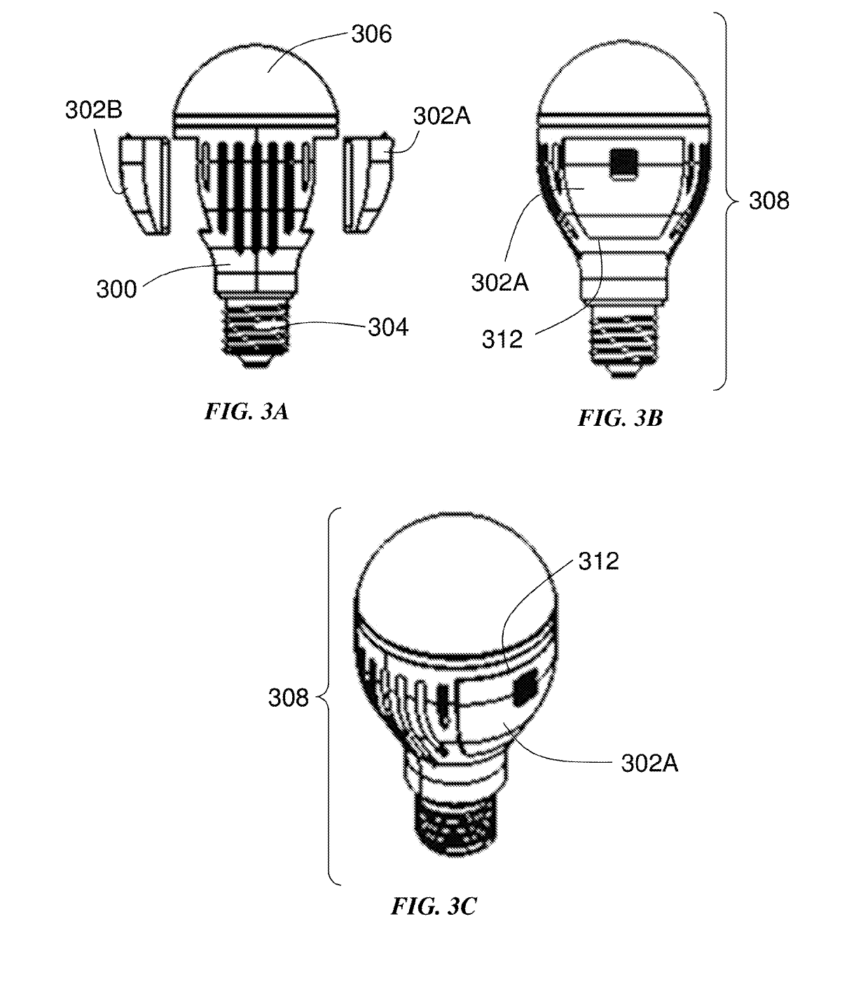

FIG. 3A is a side view schematic illustration of a modular illumination device comprising a hub 300 and modules 302A and 302B. The illumination device in FIG. 3A includes a physical interface 304 that is configured to be mated with an electrical socket. In the embodiment illustrated in FIG. 3A, physical interface 304 comprises a threaded surface configured to interface with an Edison socket. Other physical interfaces could also be used. The illumination device in FIG. 3A also comprises a light source 306. In the embodiment shown in FIG. 3A, light source 306 is located at the tip of hub 300. The light source could also be located at the side of hub 300 (in addition to, or in place of, its location at the tip of hub 300). FIG. 3B is a side view schematic illustration of the illumination device of FIG. 3A, in which modules 302A and 302B have been connected to hub 300. FIG. 3C is a perspective view schematic illustration of the illumination device of FIGS. 3A and 3B, in which modules 302A and 302B have been connected to hub 300. In certain embodiments, the hub and module can be coupled to form a unitary body having an external surface area. For example, in FIGS. 3B and 3C, hub 300 and modules 302A-B are coupled to form unitary body 308. Unitary body 308 has an external surface area that is made up of the exposed surface areas of hub 300 and modules 302A-B when they are assembled as a unitary body. According to some embodiments, the module may occupy a relatively high percentage of the external surface area of the unitary body formed by the hub and the module. For example, in some embodiments, an external surface of a module can occupy at least about 5%, at least about 10%, at least about 20%, or at least about 25% (and/or, in some embodiments, up to about 50% or more) of the external surface area of the unitary body when the hub and he module are coupled. For example, referring to FIGS. 3B and 3C, module 302A occupies about 15% of the external surface area of unitary body 308 formed by hub 300 and modules 302A-B.

In some embodiments, the hub and module can be coupled to form a unitary body having a substantially smooth surface formed between the hub and the module. That is to say, in some embodiments, when the hub and module are coupled to form a unitary body, the external surfaces of the hub and module can be aligned such that there are no substantial discontinuities formed between the hub and the module. For example, in FIG. 1A, hub 100 and modules 102 are coupled such that a substantially smooth surface is formed at the seam 112 formed between hub 100 and modules 102. As another example, in FIG. 2, hub 200 and modules 202 are coupled such that a substantially smooth surface is formed at the seam 212 formed between hub 200 and modules 202. In FIGS. 3B and 3C, hub 300 and module 302A are coupled such that a substantially smooth surface is formed at the seam 312 formed between hub 300 and 302A.

In certain embodiments, the hub and the module(s) can be configured to be removably attached to each other. That is to say, a hub and module can be configured such that they can be attached to each other and detached from each other (e.g., multiple times, such as at least 10 times, at least 100 times, at least 1000 times, or more) without substantially physically damaging or otherwise compromising the structural integrity of the hub and module.

In some embodiments, a module can be connected to and/or disconnected from the hub while the operability of the hub (and/or the operability of any other modules attached to the hub) is maintained. For example, a module can be connected to and/or disconnected from a hub while power is transmitted from a primary power source (via, for example, a wall or ceiling socket) to the hub and/or any other modules connected to the hub.

In certain embodiments, a module may be connected to a hub by applying modest physical pressure (e.g., by hand). In certain embodiments, the interface comprises a physical locking mechanism. In some such embodiments, the physical pressure is applied until a mechanical locking device is activated. In certain such embodiments, upon activating the mechanical locking device, a recognizable audible sound or noise is created indicating to a user that the hub and module are correctly connected. In some embodiments, removable modules may be held in place using one or more magnets, one or more latches, or similar structures. Such structures may be used to secure the module and/or provide an interface for electrical connections, which can provide for functional connectivity between the module and the hub.

According to certain embodiments, the hub comprises at least one connection configured to send an electrical signal to and/or receive an electrical signal from a module. The connection may be a wireless connection and/or a wired connection. Referring to FIG. 1C, for example, module 102 can comprise a plurality of electrical contact pads 114, which can be configured to conduct electricity to and/or from the module. Referring to FIG. 2, hub 200 can comprise a plurality of electrical contact pads 214, which can be configured to conduct electricity to and/or from the hub. In some embodiments, the electrical contact pads on a hub may be aligned with electrical contact pads on a module to produce electrical communication between the hub and the module. In some embodiments, an interface between the hub and the module (and/or each interface between each of the modules and the hub) comprises power and/or data connections. Any suitable power and data connections may be employed between the hub and the module(s).

In some embodiments, an interface (between a hub and a module (or modules)) may comprise at least one air inlet and/or at least one air outlet. The air inlet(s) and/or outlet(s) can be configured such that modules that utilize air flow have mechanical features that provide access upon insertion. In some embodiments, air inlet(s) and/or outlet(s) between the hub and any modules that do not require airflow may remain closed upon connecting the modules to the hub.

In some embodiments, control signal specifications and protocols are used for at least one module (e.g., for each module connected to the hub) such as, for example, to control the light source (e.g., ON/OFF, dimming), to send sensors notification(s) (e.g., related to the presence of smoke, the detection of movement, the level and/or presence of light, etc.), module ID, wake, sleep, alarm, and/or sync with airflow pulse.

It some embodiments, the physical interface between the module(s) and the hub can be standardized in size and/or shape. For example, in some cases, within a given lamp form factor, all connections between modules and hubs may be standardized in size and/or shape. In some cases, all connections between modules and hubs may be standardized in size and/or shape across multiple (e.g., all) lamp form factors. By standardizing the size and/or shape of the interface between the modules and the hub, the modules may be easily interchanged among different lamps and/or among different interface positions within a single lamp.

In certain embodiments, the aesthetic design between the module and the hub can be standardized within a lamp form factor (or, in some embodiments, across multiple lamp form factors), for example, to assist with branding of the product and product identification.

As noted above, in some embodiments, the hub comprises at least one processor, such as a microprocessor. In some embodiments, the hub is configured to receive a signal (e.g., containing information) from at least one module and/or to send a signal to at least one module. Wireless and/or wired signals may be communicated between the hub and the module(s). In some such embodiments, the hub comprises a processor (e.g., a processor comprising an IC), which can be used to process at least one signal received from at least one hub. In some such embodiments, the processor of the hub can produce a signal (e.g., based on a signal received by the hub from at least one module), which can, in certain embodiments, be subsequently sent to a module (e.g., the module from which the signal was originally received by the hub and/or to another module or modules). In some embodiments, all communication between modules is transmitted through the hub. In some such embodiments, the hub is configured to be a central processor that manages signals between a plurality of modules. In some embodiments, substantially all signal processing and/or other intelligence functions within the illumination device are performed within the hub.

In one exemplary set of embodiments, the hub contains an illumination source, processing, intelligence electronics, and an audio speaker. In some such embodiments, a module contains a smoke detector and a smoke detector sensing circuit. In certain such embodiments, upon detecting smoke, the smoke detector sensing circuit sends a signal to the hub that activates an alarm via the audio speaker. In certain such embodiments, upon detecting smoke, the smoke detector sensing circuit sends a signal to the hub that turns on a light source (e.g., to facilitate emergency evacuation).

In some embodiments, the hub contains an illumination source, processing, and intelligence electronics while a first module contains a smoke detector and a smoke detector sensing circuit, and a second module contains an audio speaker. In this embodiment, upon detecting smoke, the smoke detector sensing circuit sends a signal to the hub, the hub intelligence electronics processes this signal and sends a second signal to the audio speaker module thereby activating an alarm. In some such embodiments, upon detecting smoke, the smoke detector sensing circuit sends a signal to the hub that turns on a light source (e.g., to facilitate emergency evacuation).

In certain embodiments, the hub contains an illumination source, processing, and intelligence electronics while a first module contains a smoke detector and a smoke detector sensing circuit, a second module contains an audio speaker, and a third module contains a networking device. In certain such embodiments, upon detecting smoke, the smoke detector sensing circuit sends a signal to the hub, the hub intelligence electronics processes this signal and sends a second signal to the audio speaker module thereby activating a first alarm, and the hub intelligence electronics sends a third signal to the networking module which in turn sends a fourth signal to a second networking module connected to a second hub. In certain such embodiments, the second networking module sends a fifth signal to the second hub. In some such embodiments, the second hub intelligence electronics processes the fifth signal and sends a sixth signal to a second audio speaker module connected to the second hub thereby activating a second alarm. The intelligence electronics in the second hub could also, according to certain embodiments, turn on a light source (e.g., to facilitate emergency evacuation).

In certain embodiments, the illumination device can be configured for use with a wireless switch. For example, in some embodiments, the illumination device comprises a hub and at least one module, and the hub and/or module(s) can be configured to communication with a wireless switch.

In some such embodiments, the hub and/or module(s) include at least one sensor (e.g., a smoke sensor, a carbon monoxide sensor, a light sensor (e.g., a daylight sensor), an occupancy sensor, and/or any other sensor described herein, alone or in combination with each other, and present as a single sensor or multiple sensors). In some embodiments, the hub and/or module(s) include an energy storage device (e.g., a battery such as a lithium-ion battery, a nickel cadmium battery, and the like). In some embodiments, the hub and/or module(s) include a communication device (e.g., a wireless communication device). In some embodiments, the hub and/or module(s) include an sound-producing device and/or a light-producing device. In certain embodiments, the hub and/or module(s) comprise a controller. The controller can send and/or receive electrical signals. In some embodiments, the controller routes electrical signals between a switch and a bulb, a bulb and a module, a bulb and another bulb, and/or a bulb and an external device.

In some embodiments, the illumination device can be configured for use as an emergency light bulb. For example, in some embodiments, a bulb may lose electricity while the bulb is in use. The bulb can remain on and switch to a backup battery. Light output can dim slowly to an emergency level, in some embodiments. In some embodiments, the emergency level corresponds to a lumen output from the bulb that is needed to achieve 10 lux of illumination in the typical home. In some embodiments, a bulb may lose electricity while the bulb is not in use. In some such embodiments, the bulb can be configured to remain off. In some such embodiments, a switch can be turned on (e.g., by a user), and the bulb can light up at the emergency level. In some embodiments, the emergency light bulb can be configured to power on at full normal power upon losing electricity. In certain such embodiments, a presence sensor may be coupled to the emergency light bulb such that the bulb is only turned on when one or more people are in the vicinity of the bulb.

In some cases, such as in the event of a power outage or emergency situation, all bulbs are turned on in emergency lighting mode using, for example, an inter-bulb communication protocol. The trigger may be, in certain embodiments, internal. For example, the trigger can be, in some embodiments, from a bulb that was on at the time of the outage and/or from a module that detects a specific emergency situation. The trigger may be, in some embodiments, external (e.g., in the form of a notification from a utility).

In some embodiments, the illumination device can be configured to operate over an extended lifetime. For example, in some embodiments, a rechargeable battery may be installed in a hub. The battery may be installed, for example, by a user. In some embodiments, the battery module utilizes power provided by the hub to recharge. The battery module can provide additional hours for lighting or other applications in emergency operation, according to some embodiments. In certain embodiments, if a battery is discharged (e.g., exhausted) during an extended duration outage, it can be recharged, for example, via ports provided on the module. Recharging can be achieved, for example, via a vehicle power adapter or wall outlets. Charging may be achieved, for example, via cellphone chargers or other cables.

In some embodiments, the illumination device can be configured to provide a notification during an emergency. In some embodiments, a connectivity module can be installed in the hub. The connectivity module may use, for example, WiFi, ZigBee, Bluetooth, or any other wireless protocol as a means of communicating (e.g., via the internet). The module may also have (in addition to or in place of the connectivity systems described above) GSM or other cellular communication technology, which can be used, for example, to provide robust communication during a power outage. In some embodiments, the connectivity module may be in the form of a gateway that translates the wireless protocol used for communications (e.g., between bulbs or between a bulb and a switch) to the wireless protocol used for communications to the internet and/or a phone. In some embodiments, the connectivity module can be configured to interface with phones and/or computers (e.g., laptops), for example via an “app,” which can allow, according to some embodiments, a user to configure the bulb and/or switch installations.

In some embodiments, the connectivity module can be used to send notifications to a phone or other device, for example, to a customer or to others (e.g., others enabled by the customer). Examples of notifications that can be sent include, but are not limited to, notification of a power outage and notification of a return of power. Additional notifications such as smoke and/or carbon monoxide alarms can be enabled, for example, when other modules are added to the hub (e.g., a smoke alarm, a carbon monoxide alarm, and/or or a device that hears and identifies activation of existing smoke alarm installation in the home). The notification module may relay alerts from other sensors in the home that can communicate with the hub, in some embodiments. Examples of notifications include, but are not limited to, activation of smoke or carbon monoxide alarm in a vacation or remote home, notification of a power outage and/or or smoke/CO emergency in a relative's (e.g., parent's) home, and the like. Notifications may include, in some embodiments, the location of a specific hub(s) where the event (e.g., emergency) has been triggered. Notifications may include, in certain embodiments, information from occupancy sensing in the room. Such information may be used, for example, by emergency and/or rescue personnel.

In some embodiments, the illumination device can be configured to operate as a smoke and/or carbon monoxide alarm. This can be achieved, for example, by incorporating a smoke and/or carbon monoxide alarm module. In some embodiments, smoke and/or carbon monoxide alarm modules may only include sensors and receive power from the hub and use a separately installed alarm module to trigger the alarm. In some embodiments, smoke and/or carbon monoxide alarm modules may include sensors and a backup battery and use hub power in normal mode to sound the alarm. In certain embodiments, smoke and/or carbon monoxide alarm modules may include a sensor, battery backup, and audio alarm in a single module.

In some embodiments, the illumination device can be configured to activate light during an emergency. Emergencies (e.g., smoke and/or carbon monoxide alarm activation) can result, in some embodiments, in activation of the illumination light source associated with a hub, for example, at full brightness level, which can allow for safe and rapid evacuation. In some cases, activation may be triggered using light sensors. In some embodiments, the illumination light source will turn on using a backup battery whether it is night or day. In some embodiments, the illumination light source will remain at full brightness until the battery is exhausted and/or until the alarm is silenced. Other modes such as strobing and/or flashing of an illumination light source may also be used to alert occupants during emergency situations. In some embodiments, a smoke and/or carbon monoxide alarm module installed in the hub is activated. In some such embodiments, the illumination light source is turned on immediately while sounding the alarm. In some embodiments, other illumination light sources associated with other hubs are notified by the first hub, and are turned on.

In some embodiments, the illumination device can be configured to perform audio sensing. For example, in one embodiments, a listening device may be installed on a hub. The listening device can be used to identify specific tones emitted by smoke and/or a carbon monoxide alarm. According to certain embodiments, when an existing smoke or carbon monoxide alarm in a home is activated, the listener device turns on an illumination light source installed in the hub, and other bulbs in communication with the first hub may also be turned on. Audio sensing and/or filtering can be used to identify and/or trigger based on other aural signals in the environment (e.g., a doorbell, HVAC operation, a power outage (e.g., via a sudden decrease in ambient noise level), TV operation, and/or an intrusion). Each trigger can, according to some embodiments, drive a specific response such as a notification, light activation, alarm activation, and the like.

In some embodiments, the illumination device can be configured to perform light control via a switch. In some embodiments, an illumination device and a wireless switch can be used to configure light control without rewiring. For example, in some embodiments, illumination devices can be paired with switches. According to some such embodiments, multiple light sockets within an area can be controlled using multiple switches, for example, by installing various combinations of wireless switches and bulbs. In some embodiments, each switch replaces the wallplate of an existing light switch while maintaining the internal wiring in a substantially unchanged state. The old switch can be forced to remain in the ON position by the new switch. The new switch can be configured to provide ON and OFF and dimming controls that are wirelessly sent to the illumination device (e.g., the hub of the illumination device). Additional controls such as ALL ON or ALL OFF and/or other lighting scenes may also be provided on the switch. Various configurations are possible, such as one switch controlling multiple illumination devices or multiple switches controlling the same illumination device. As one example, a pathway to a particular location (e.g., a bedroom) could be lit by operation of a single switch (e.g., via a user) that controls multiple illumination devices. With two switches and an illumination device, a user could provide an additional light switch for a specific location (e.g., for a cellar at the top or bottom of the stairs) where only one light switch had been present before (e.g., at the bottom or top of the stairs, respectively). According to certain embodiments, the existing switch can be replaced by a new switch and/or a new switch can also be installed on the wall at a convenient location.

In some embodiments, the illumination device can be configured to include a sound-producing module (e.g., a speaker module). Such devices can be used, for example, to provide ambient music, an alarm, or the like. In one embodiments, a sound-producing module (e.g., a speaker or audio or alarm module) can be installed in the hub to provide music, notifications, intercom, and/or alarm functions. According to certain embodiments, the illumination device can be configured to sound an alarm. For example, in some embodiments, in the event of a smoke or carbon monoxide emergency, the sound-producing module can be notified (e.g., by an interbulb wireless communication and/or by a notification module). In some embodiments, an audio alarm signal or a custom voice message recorded by the user is relayed. The initial notification may be triggered, for example, by a resident smoke and/or carbon monoxide alarm module or by a listener device that identifies the tone emitted by smoke and/or carbon monoxide alarm module external to the illumination device.

In some embodiments, the alarm and/or audio signal may be customized based on the specific needs of a user (e.g., a resident). For example, in some embodiments, the tone and amplitude may be maintained or changed such that it is most effective for waking a particular person (e.g., children, seniors, or those that have a hearing disability). The alarm module may be, in some embodiments, independently placed in a hub which is in a socket that is close to the location most effective to notify affected individuals.

In some embodiments, the module can be configured to play music. In some embodiments, occupancy sensing may be used to modulate the volume of speaker modules installed in the hub. The volume of each speaker can be, in some embodiments, adjusted (e.g., optimized) to provide the best audio experience based on the location of a user (e.g., in a particular location within a house and/or within a room). In some embodiments, multiple audio streams can be delivered. For example, in some embodiments, multiple audio stream can be delivered such that two (or more) speakers, each in the vicinity of a different user, plays an audio stream of a user's choice. The audio can be configured, in some embodiments, to seamlessly transition from one speaker to another, for example, as a user moves around a house. The audio can be configured, in some embodiments, to go silent if two or more users congregate in same room or under the same speaker.

In some embodiments, the illumination device can function as an emergency lighting device.

Light sources during power outages tend to be portable and temporary (e.g., flashlights, lanterns, cellphone lights, candles, and the like). Such light sources are generally activated after the power has been lost, and generally tend to run using alternative power sources (e.g., batteries, solar, energy harvesting, and the like). In certain embodiments, the illumination devices described herein can be used both as a normal light bulb as well as a light source that stays on after power to the illumination device has been lost (e.g., via a power outage).

Because a light circuit can be switched off by a light control switch, it can be challenging for the device connected to the light socket to detect the outage. Certain embodiments relate to methods by which such outages may be detected.

In some embodiments, an “outage detection module” can be plugged into an outlet. The outage detection module can be configured, in some embodiments, such that it is not switched off by a light control switch. The outlet detection module can be used, in some embodiments, to send a beacon to devices (e.g., all devices within in a room, a floor, a building, etc.) when power is present. In the case of a power outage, the beacon signal ceases, and all devices configured to receive the beacon register the outage event. In some embodiments, the outage detection module can be replaced or supplemented by a unit located at or near the electrical service box and be used to detect a radiated electric field from the line coming into the building and send a beacon to the devices. In some embodiments, the outage detection module can be included in a light control switch. This can be achieved, for example, by replacing an existing light switch with a new light switch that includes outage detection features (e.g., a wireless beacon). In certain embodiments, the outage detection module can be secured to the outlet cover, for example, using the screw hole that holds the outlet cover in place or by using another mechanism. In this way, inadvertent removal of the outage detection module can be avoided.

Portable light sources (e.g., flashlights, lanterns, and the like) have light control accessible using a push button or a switch. These light sources tend to be used on a temporary basis (e.g., during a power outage and/or to access an area with poor lighting conditions). For more permanent lighting sources (lamp, light sockets), the light control generally on the lamp or on the wall. To include an outage detection feature in a device connected to a light socket (e.g., an illumination device) generally involves keeping the light socket energized. This could be achieved, for example, by keeping a light control switch in the ON position. However, doing so would eliminate the control of the light in the room and would therefore require an alternative means to control the light circuit. According to certain embodiments, an emergency illumination device could be installed in a lamp or a light socket and can be configured to remain on during a power outage. Certain embodiments relate to a light control method that can be used to control the light source. There are various methods available to control the light source in the emergency light bulb while the original light switch is kept in the ON position. Some examples of wireless methods that could be used by the new light control panel include, but are not limited to, Standard RF communication protocol (Bluetooth, ZigBee, WiFi, Z-Wave, ANT+), proprietary RF communication (433/868/915/2400 MHz ISM bands), infrared communication (e.g., similar to remote control), communication using High frequency sound (e.g., ultrasound). According to certain embodiments, a new light control panel can be powered by alternative means (e.g., a battery, energy harvesting, and the like) and can remain operational during a power outage. In some such embodiments, the light source in the emergency illumination device could be turned on/off (or dimmed intensity) during power outage.

According to certain embodiments, for light sockets that are controlled with wall switches, a light control panel is disclosed that will keep the original light control switch in the ON position to maintain the light socket energized. This new light control panel can be configured, according to some embodiments, to cover the original light control switch. In some embodiments, the new light control panel can be configured to prevent the original switch from being turned off inadvertently. The light control panel can be configured to simplify the detection of the outage at the light socket. By maintaining the light socket such that it is always energized, performance of various components (e.g., a security camera, monitoring sensor, alarm, sound, etc.) associated with the illumination device within the light socket can be maintained, even when the light source is off. In certain embodiments in which the illumination device is configured to use in a lamp application, the new light control panel can be used to control the light sources.

The light control panel may provide, according to certain embodiments, one or more of the following functionalities: controlling the light source (e.g., ON/OFF, light intensity dimming, light color temperature change); configuring additional features in the light socket (e.g., light turn off timer, light turn-on with sensors); adding additional bulbs to the control circuit (e.g., pairing); providing status indication of the light socket (e.g., backup battery level, alarm detected); and/or enhancing the control of the light (e.g., gesture sensing, proximity).

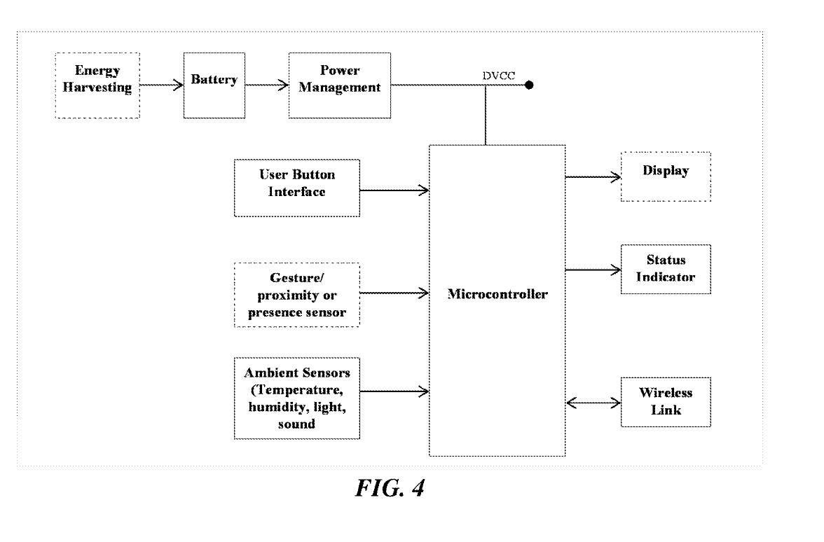

FIG. 4 is a schematic block diagram illustrating the configuration of an exemplary light control panel, according to certain embodiments. The new light control panel may include one or more of a wireless link, a controller, a user button interface, a battery, energy harvesting, ambient sensors, and/or gesture, proximity, and/or presence sensors.

In some embodiments, the light control panel comprises a wireless link. The wireless link can be used to communicate with the emergency illumination device. The wireless link could be achieved using any of the wireless communication protocols described elsewhere herein. In certain embodiments, to increase battery life, the wireless link can be configured such that it will only be active “on-demand” (e.g., when a user button interface is used).

In some embodiments, the light control panel comprises a controller (e.g., a microcontroller). The controller can be configured, in some embodiments, to control the wireless link and/or monitor buttons and sensors. The controller can be configured, in certain embodiments, to control a status indicator and/or a display. To increase battery life, the microcontroller can be maintained, according to some embodiments, in low power mode and can be activated, e.g., via a button and/or by a periodic timer to measure the sensors.

In some embodiments, the light control panel comprises a user button interface. Such an interface can be configured (e.g., by a user), in some embodiments, to control the light source and/or other light socket features. In some embodiments, the user button interface can be implemented with mechanical buttons or switch, capacitive touch buttons, and/or a touch panel/display.

The light control panel comprises, in some embodiments a power source such as a battery, a capacitor, and/or an energy buffer (e.g., if energy harvesting is used). In some embodiments, the power source can be configured to power all components on the light control panel. The power source can be configured to power all components on the light control panel independently from the light socket electrical circuit. The power source can be used to provide sustained energy during the wireless communication with the bulb and for the microcontroller to monitor all ambient sensors and other sensors.

In certain embodiments, the light control panel comprises energy harvesting. The energy harvesting component can be configured to, for example, harvest energy from various sources (e.g., solar, thermal, kinetic/motion, RF energy, and the like). The energy harvest from the energy harvesting can be used, for example, to charge the power source (e.g., an energy buffer, capacitor, and/or battery).

The light control panel comprises, in some embodiments, ambient sensors. The ambient sensors can be used, for example, to determine temperature, humidity, light (e.g., ambient light), sound, movement, and/or other stimuli. In some embodiments, the sensors are configured to perform environmental monitoring. The sensors can be installed, in some embodiments, on the light control panel. According to certain embodiments, the sensor information is relayed to an emergency illumination device (which can be associated with, in some embodiments, another hub within a hub network) via a wireless link. In some embodiments, the light control panel comprises gesture, proximity, and/or presence sensors. For example, the light control panel can comprise a gesture sensor that responds to movements (e.g., hand waves or other hand signs, and the like). A movement detector can be used, for example, to detect the presence of an object or person in a room. The gesture sensing can be used, for example, to control the light output of the illumination device. In some embodiments, the light control pane comprises a proximity sensor, which can be used, for example, to detect an object (e.g., a hand) that is close to the proximity sensor and respond by sending a signal to perform an action (e.g., turning a light on and/or off).

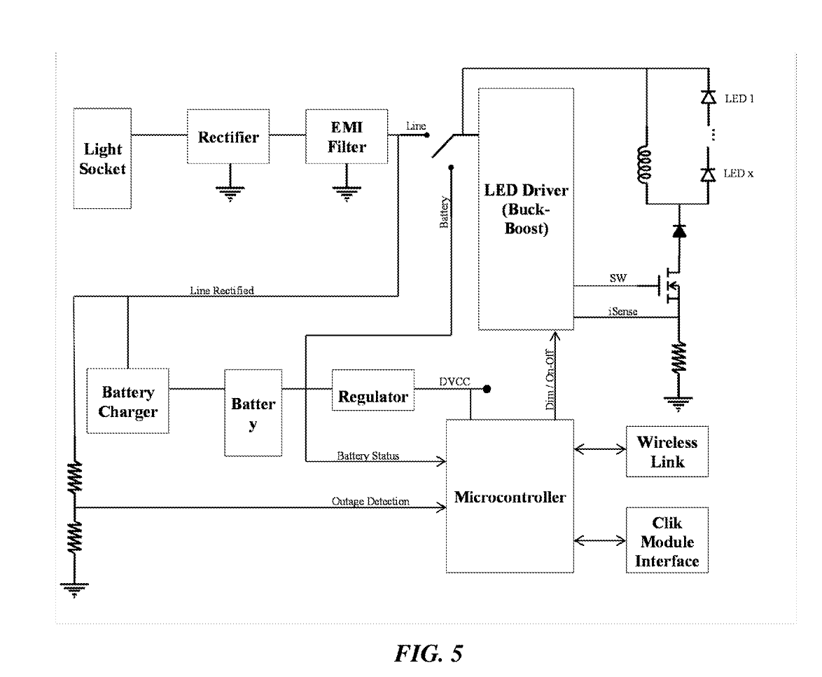

FIG. 5 is a block diagram of an exemplary emergency illumination device.

In some embodiments, the inventive methods described herein involve using a light switch cover to maintain a light socket in an energized state, as described in more detail below. In some embodiments, the inventive systems described herein include a wireless panel configured to control a light source during a power outage and/or a light control panel that includes additional room sensors. Some embodiments relate to a pairing method used to associate multiple illumination devices with a single light control switch. Certain embodiments relate to systems and solutions to reconfigure light control without the need to rewire.

Certain embodiments relate to systems and methods for retrofitting electrical switches for use with various of the systems and devices described herein. In addition to providing lighting, certain of the systems and articles described herein provide non-lighting functionality (e.g., video, audio, security functionality, WiFi range extension, smoke and/or CO detection, sound detection, alarm, video detection, etc.). In many instances, it may be desirable to keep the non-lighting functionality active while maintaining the ability to switch the lighting functionality on and/or off. If, however, the hub is connected to an existing electrical socket, turning a switch connected to the electrical socket to an “off” position (i.e., a position in which electrical current is not passed through the switch) may result in the loss of all functionality (i.e., lighting and non-lighting functionality) within the hub and/or modules connected to the hub. Certain of the inventive embodiments described herein relate to retrofitting an existing electrical switch, for example, such that power is continuously supplied to the hub while the lighting functionality (e.g., within the hub and/or a module connected to the hub) can be switched on and off.

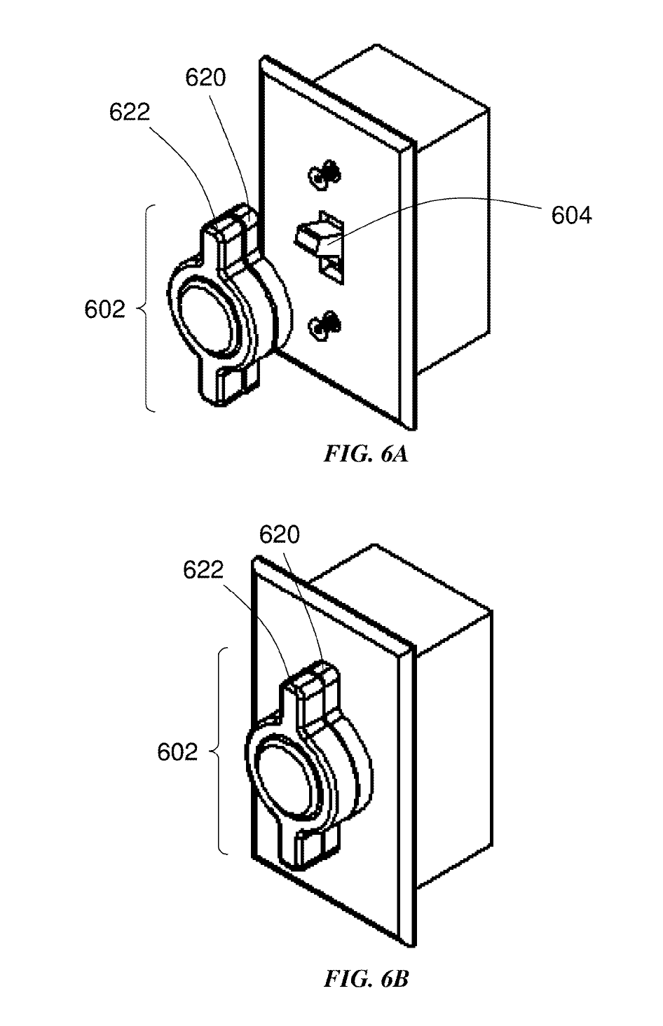

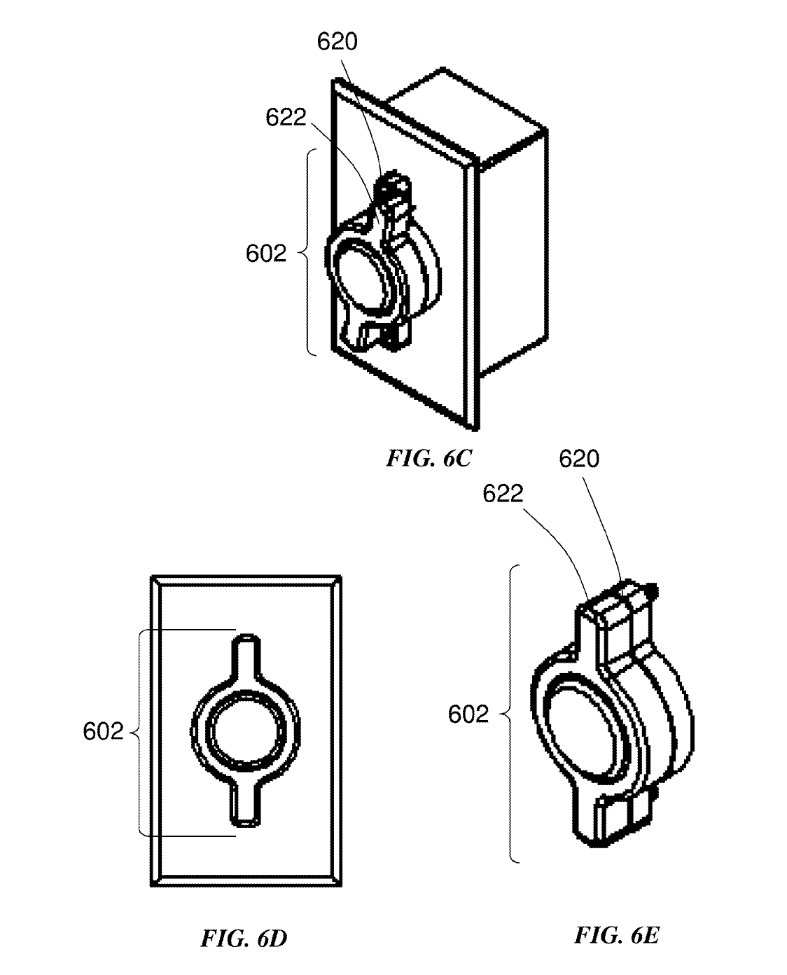

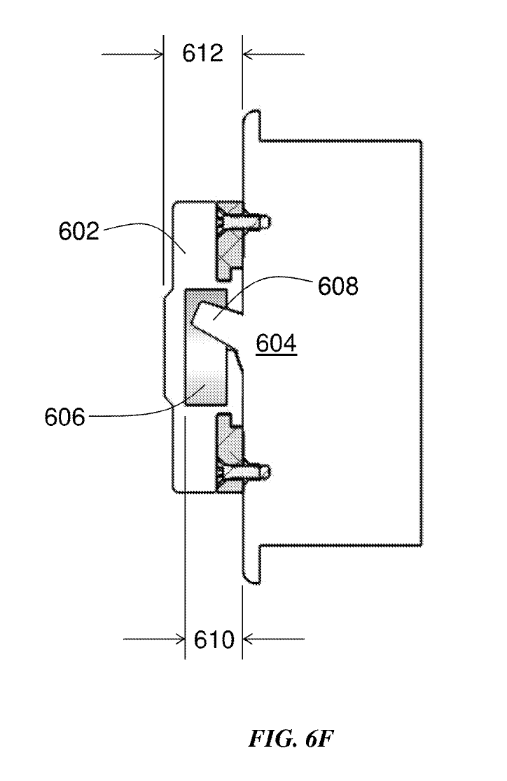

Certain embodiments involve fixing a state of a wall-mounted switch within an electric circuit to an “on” position (i.e., a position in which electrical current is allowed to pass through the switch). In certain embodiments, the state of the wall-mounted switch can be fixed to an “on” position using a cover. FIGS. 6A-6F are schematic illustrations showing one such set of embodiments. As illustrated in FIGS. 6A-6F, cover 602 is placed over a conventional wall-mounted switch 604. As shown in FIG. 6F, cover 602 can be configured such that, when the cover is placed over wall-mounted electric switch 604, the state of the wall-mounted electric switch is fixed in an “on” position. The cover can fix the state of the wall-mounted switch using a variety of mechanisms. For example, in some embodiments, the cover comprises an indentation configured to house a protrusion of the switch. Referring to FIG. 6F, for example, cover 602 comprises indentation 606, into which protrusion 608 of switch 604 can be positioned. Once cover 602 is positioned over switch 604, the switch can be fixed in the “on” position. In certain embodiments, the indentation in the cover extends into the bulk of the cover a distance that is at least 10%, at least 25%, at least 50%, or at least 75% of the thickness of the cover. For example, in FIG. 6F, indentation 606 of cover 602 extends into the bulk of the cover a distance (shown as dimension 610) that is about 75% of the thickness of cover 602 (shown as dimension 612). Other mechanisms can also be used to fix a wall-mounted switch in an “on” position. For example, in certain embodiments (e.g., in some embodiments in which the switch comprises a push-button switch), the cover comprises a protrusion that maintains a portion of the wall-mounted switch in a depressed position to maintain the switch in the “on” position.

In certain embodiments, the cover at least partially (or substantially completely) encloses the wall-mounted switch that controls power supplied to a fixture via an electric circuit. Enclosing the wall-mounted switch can be useful, in certain cases, in preventing the switch from being switched to the “off” position, which could result in cutting off power to a hub electrically connected to the switch. Referring to FIGS. 6A-6B, for example, cover 602 is shown being attached to switch 604 by mounting the cover using the pre-positioned screwed used to attached the switch plate to the wall. In FIG. 6B, cover 602 completely encloses the wall-mounted switch. In other embodiments, the cover may cover only a portion of the wall-mounted switch (e.g., a portion sufficiently large that accidental switching of the switch is effectively avoided).

According to certain embodiments, the cover is configured to prevent inadvertent operation of the wall-mounted switch while providing access for occasional operation of the wall-mounted switch. For example, the cover may comprise an opening through which the underlying wall-mounted switch can be accessed. The opening may be covered (e.g., using a cover that can be removed to gain access to the underlying wall-mounted switch) or uncovered.

The cover can be mounted over the wall-mounted switch, according to certain embodiments. The cover can be mounted using any suitable mounting technique. For example, the cover can be mounted using at least one screw, a magnetic mounting, a frictionally engaged mounting, and/or an adhesive.

The cover can be configured to at least partially enclose any type of wall-mounted switch. For example, in some embodiments, the cover is configured to at least partially enclose a toggle switch and/or a dimmer switch.

In some embodiments, the cover comprises a base unit and a wireless switch. One such embodiment is illustrated in FIGS. 6A-6E. In FIGS. 6A-6E, cover 602 comprises base unit 620 and wireless switch 622. The base unit and the wireless switch may be, in some embodiments, detachably coupled to each other. In certain embodiments, the base unit is configured to fix the state of the wall-mounted electric switch in an “on” position. For example, base unit 620 may include an indentation, similar to the indentation arrangement illustrated in FIG. 6F.

In certain embodiments, the cover comprises at least one accelerometer. The accelerometer may be positioned, for example, in the wireless switch or at any other location within the cover. In certain embodiments, the intensity of a light-emitting element can be adjusted by rotating the cover. For example, in some embodiments, rotating the cover can adjust the intensity of a light-emitting element electrically connected to a wall-mounted switch that is at least partially enclosed by the cover. In some embodiments, the rotation can involve rotating the wireless switch relative to the base unit, as shown in FIG. 6C.

According to certain embodiments, the cover comprises at least one sensor, such as a motion sensor, a light sensor (e.g., a daylight or other ambient light sensor), a temperature sensor, a humidity sensor, an occupancy sensor, and/or any other sensor described herein, alone or in combination with each other, and present as a single sensor or multiple sensors). In certain embodiments, the cover comprises a sensor configured to detect motion, daylight, and/or temperature.

In some embodiments, the cover comprises a power source, such as a battery and/or any other of the power sources described elsewhere herein. The power source may be used, in some embodiments, to provide power to the wireless switch of the cover. For example, according to certain embodiments, a power source can be mounted within the wireless switch of the cover. In some such embodiments, after the wireless switch is removed from the base unit of the cover, the power supply can be used to power the switching function of the wireless switch, which can allow for turning a light-emitting element “off” and “on” and/or for adjusting the intensity of a light-emitting element.

In some embodiments, a light-emitting element can be configured to receive power from the electric circuit in which the wall-mounted switch is positioned. The light emitting element can be, in some embodiments, switched between an “on” state and an “off” state. In some such embodiments, the light emitting element can be switched between and “on” state and an “off” state without switching the wall-mounted switch. This can be accomplished, for example, using a wireless switch in communication with the light-emitting element. In certain embodiments, the wireless switch can at least partially enclose the wall-mounted switch. The wireless switch can function, for example, via WiFi, ZigBee, Bluetooth, Z-Wave, ANT+, an infrared signal, an ISM radio band, and/or ultrasound, and/or any other suitable communication protocol. In some embodiments, the wireless switch is part of the cover (e.g., described above) used to fix the wall-mounted switch in the “on” position. In other embodiments, the wireless switch is separate from the cover used to fix the wall-mounted switch in the “on” position.

In certain embodiments, power is provided to a hub electrically connected to the wall-mounted switch. For example, in some embodiments, a hub can be connected to a light socket that is electrically connected to a wall-mounted switch (which can be fixed in an “on” position, for example, using a cover). In certain embodiments, the light-emitting element that is switched between an “on” state and an “off” state by the wireless switch is part of the hub. According to certain embodiments, the light-emitting element can be switched between an “on” state and an “off” state without switching the power provided to the hub “on” and “off.” This can be accomplished, for example, by configuring the hub and/or the light-emitting element such that power is supplied to the light-emitting element independently of the power supplied to the module.

The light-emitting element in the hub may be detachable from the hub, or it may be integrally connected to the hub. The hub may be, in some embodiments, configured to receive at least one module via an interface. In certain embodiments, the hub is configured to provide power from the wall-mounted switch to the module. The hub and/or module may have any of the configurations of hubs and/or modules described elsewhere herein.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

What is claimed is:

1. A hub, comprising:
a fitting configured to be mounted in a light socket; and
a networking component,
wherein the hub is configured to receive at least one module via an interface.

2. A hub, comprising:
a fitting configured to be mounted in a light socket,
wherein the hub is configured to receive at least one module via an interface such that the hub and module can be coupled to form a unitary body having an external surface area, and
wherein an external surface of the module occupies at least about 5% of the external surface area of the unitary body when the hub and he module are coupled.

3. A hub, comprising:
a fitting configured to be mounted in a light socket,
wherein the hub is configured to receive at least one module via an interface such that the hub and module can be coupled to form a unitary body having a substantially smooth surface formed between the hub and the module.

4. A hub, comprising:
a fitting configured to be mounted in a light socket,
wherein the hub is configured to receive at least one module having a volume of at least about 13 cm³ via an interface such that the hub and module can be coupled to form a unitary body.

5. A hub, comprising:
an illumination source configured to emit light at a luminous flux of at least about 375 lumens; and
a networking component,
wherein the hub is configured to receive at least one module via an interface.

6. A hub, comprising:
an illumination source configured to emit light at a luminous flux of at least about 375 lumens,
wherein the hub is configured to receive at least one module via an interface such that the hub and module can be coupled to form a unitary body having an external surface area, and
wherein an external surface of the module occupies at least about 5% of the external surface area of the unitary body when the hub and he module are coupled.

7. A hub, comprising:
an illumination source configured to emit light at a luminous flux of at least about 375 lumens,
wherein the hub is configured to receive at least one module via an interface such that the hub and module can be coupled to form a unitary body having a substantially smooth surface formed between the hub and the module.

8. A hub, comprising:
an illumination source configured to emit light at a luminous flux of at least about 375 lumens,
wherein the hub is configured to receive at least one module having a volume of at least about 13 cm³ via an interface such that the hub and module can be coupled to form a unitary body.

9. The hub of any one of claims 5-8, wherein the hub comprises a fitting configured to be mounted in a light socket.

10. The hub of any one of claims 1-4 and 9, wherein the fitting comprises at least one of a screw-type fitting, a twist and lock fitting, a BI pin type fitting, a fluorescent pin type fitting, a compact fluorescent type fitting, a bayonet type fitting, and a filament type fitting.

11. The hub of any one of claims 1-4 and 9-10, wherein the light socket comprises an Edison socket.

12. The hub of any one of claims 1-4 and 9-10, wherein the light socket comprises at least one of a screw-type socket, a twist and lock socket, a BI pin type socket, a fluorescent pin type socket, a compact fluorescent type socket, a bayonet type socket, and a filament type socket.

13. The hub of any one of claims 1-12, wherein the hub comprises at least one connection configured to send an electrical signal to and/or receive an electrical signal from a module.

14. The hub of claim 13, wherein the connection is a wired connection.

15. The hub of claim 13, wherein the connection is a wireless connection.

16. The hub of any one of claims 1-4 and 9-15, wherein the hub comprises an illumination source.

17. The hub of any one of claims 5-8 and 16, wherein the illumination source comprises at least one light-emitting diode (LED).

18. The hub of any one of claims 2-17, wherein the hub comprises a networking component.

19. The hub of any one of claims 1 and 18, wherein the networking component comprises a wireless communication device.

20. The hub of any one of claims 1 and 18, wherein the networking component is configured to communicate with a remote controller unit.

21. The hub of claim 20, wherein the remote controller unit is a portable electronic device.

22. The hub of claim 21, wherein the portable electronic device is a mobile phone.

23. The hub of any one of claims 1-22, wherein the hub comprises at least one power source.

24. The hub of claim 23, wherein the power source comprises a battery.

25. The hub of any one of claims 1-24, wherein the hub comprises a thermal management system.

26. The hub of any one of claims 1-25, wherein the hub comprises at least one sensor.

27. The hub of any one of claims 1-26, wherein the hub comprises at least one processor.

28. The hub of any one of claims 1-27, wherein the interface comprises a physical locking mechanism.

29. The hub of claim 28, wherein the physical locking mechanism is configured such that engagement of the physical locking mechanism produces an audible sound.

30. The hub of any one of claims 1-29, wherein the interface comprises an air inlet.

31. The hub of any one of claims 1-30, wherein the interface comprises an air outlet.

32. A system, comprising:
a hub comprising a fitting configured to be mounted in a light socket and a networking component; and
a module coupled to the hub via an interface.

33. A system, comprising:
a hub comprising a fitting configured to be mounted in a light socket; and
a module coupled to the hub via an interface to form a unitary body having an external surface area,
wherein an external surface of the module occupies at least about 5% of the external surface area of the unitary body.

34. A system, comprising:
a hub comprising a fitting configured to be mounted in a light socket; and
a module coupled to the hub via an interface to form a unitary body having a substantially smooth surface formed between the hub and the module.

35. A system, comprising:
a hub comprising a fitting configured to be mounted in a light socket; and
a module having a volume of at least about 13 cm³ coupled to the hub via an interface to form a unitary body.

36. A system, comprising:
a hub comprising an illumination source configured to emit light at a luminous flux of at least about 375 lumens and a networking component; and
a module coupled to the hub via an interface.

37. A system, comprising:
a hub comprising an illumination source configured to emit light at a luminous flux of at least about 375 lumens; and
a module coupled to the hub via an interface to form a unitary body having an external surface area,
wherein an external surface of the module occupies at least about 5% of the external surface area of the unitary body.

38. A system, comprising:
a hub comprising an illumination source configured to emit light at a luminous flux of at least about 375 lumens; and
a module coupled to the hub via an interface to form a unitary body having a substantially smooth surface formed between the hub and the module.

39. A system, comprising:
a hub comprising an illumination source configured to emit light at a luminous flux of at least about 375 lumens; and
a module having a volume of at least about 13 cm³ coupled to the hub via an interface to form a unitary body.

40. The system of any one of claims 36-39, wherein the hub comprises a fitting configured to be mounted in a light socket.

41. The system of any one of claims 32-35 and 40, wherein the fitting comprises at least one of a screw-type fitting, a twist and lock fitting, a BI pin type fitting, a fluorescent pin type fitting, a compact fluorescent type fitting, a bayonet type fitting, and a filament type fitting.

42. The system of any one of claims 32-35 and 40-41, wherein the light socket comprises an Edison socket.

43. The system of any one of claims 32-35 and 40-41, wherein the light socket comprises at least one of a screw-type socket, a twist and lock socket, a BI pin type socket, a fluorescent pin type socket, a compact fluorescent type socket, a bayonet type socket, and a filament type socket.

44. The system of any one of claims 32-43, wherein the hub comprises at least one connection configured to send an electrical signal to and/or receive an electrical signal from a module.

45. The system of claim 44, wherein the connection is a wired connection.

46. The system of claim 44, wherein the connection is a wireless connection.

47. The system of any one of claims 32-35 and 40-46, wherein the hub comprises an illumination source.

48. The system of any one of claims 36-39 and 47, wherein the illumination source comprises at least one light-emitting diode (LED).

49. The system of any one of claims 33-48, wherein the hub comprises a networking component.

50. The system of any one of claims 32 and 49, wherein the networking component comprises a wireless communication device.

51. The system of any one of claims 32 and 50, wherein the networking component is configured to communicate with a remote controller unit.

52. The system of claim 51, wherein the remote controller unit is a portable electronic device.

53. The system of claim 52, wherein the portable electronic device is a mobile phone.

54. The system of any one of claims 32-53, wherein the hub comprises at least one power source.

55. The system of claim 54, wherein the power source comprises a battery.

56. The system of any one of claims 32-55, wherein the hub comprises a thermal management system.

57. The system of any one of claims 32-56, wherein the hub comprises at least one sensor.

58. The system of any one of claims 32-57, wherein the hub comprises at least one processor.

59. The system of any one of claims 32-58, wherein the interface comprises a physical locking mechanism.

60. The system of claim 59, wherein the physical locking mechanism is configured such that engagement of the physical locking mechanism produces an audible sound.

61. The system of any one of claims 32-60, wherein the interface comprises an air inlet.

62. The system of any one of claims 32-61, wherein the interface comprises an air outlet.

63. The system of any one of claims 32-62, wherein the module comprises at least one power source.

64. The system of any one of claims 32-63, wherein the module comprises at least one sensor.

65. The system of any one of claims 32-64, wherein the module comprises at least one audio device.

66. The system of any one of claims 32-65, wherein the module comprises at least one video device.

67. The system of any one of claims 32-66, wherein the module comprises at least one security device.

68. The system of any one of claims 32-67, wherein the module comprises at least one networking device.

69. The system of any one of claims 32-68, wherein the module comprises at least one interface configured to communicate with remote devices.

70. The system of claim 69, wherein the module comprises a bluetooth networking device.

71. A cover configured to at least partially enclose a wall-mounted electric switch and configured such that, when the cover is placed over the wall-mounted electric switch, the state of the wall-mounted electric switch is fixed in an on position, wherein the cover comprises a wireless switch configured to switch a light-emitting element between an on state and an off state.

72. The cover of claim 71, wherein the cover is configured to substantially completely enclose the switch.

73. The cover of any one of claims 71-72, wherein the wireless switch functions via WiFi, ZigBee, Bluetooth, Z-Wave, ANT+, an infrared signal, an ISM radio band, and/or ultrasound.

74. The cover of any one of claims 71-73, wherein the cover comprises an indentation configured to house a protrusion of the switch.

75. The cover of claim 74, wherein the indentation extends into the bulk of the cover a distance that is at least 10% of the thickness of the cover.

76. The cover of any one of claims 71-75, wherein the cover comprises at least one accelerometer.

77. The cover of any one of claims 71-76, wherein the cover comprises at least one sensor.

78. The cover of claim 77, wherein the sensor is configured to detect motion, daylight, and/or temperature.

79. The cover of any one of claims 71-78, wherein:
the cover comprises a base unit configured to fix the state of the wall-mounted electric switch in an on position, and
the wireless switch is detachably coupled to the base unit.

80. The cover of any one of claims 71-79, wherein the cover is configured to prevent inadvertent operation of the wall-mounted switch while providing access for occasional operation of the wall-mounted switch.

81. The cover of claim 80, comprising a opening through which the underlying wall-mounted switch can be accessed.

82. The cover of any one of claims 71-81, wherein the cover is configured to at least partially enclose a toggle switch and/or a dimmer switch.

83. A system for retrofitting an electric switch, comprising:
a cover at least partially enclosing a wall-mounted switch that controls power supplied to a fixture via an electric circuit, the cover fixing the state of the wall-mounted switch in an on position; and
a wireless switch in communication with a light-emitting element receiving power from the electric circuit within which the wall-mounted switch is positioned, the wireless switch configured to switch the light-emitting element between an on state and an off state.

84. The system of claim 83, wherein the cover is configured to substantially completely enclose the switch.

85. The system of any one of claims 83-84, wherein the wireless switch functions via WiFi, ZigBee, Bluetooth, Z-Wave, ANT+, an infrared signal, an ISM radio band, and/or ultrasound.

86. The system of any one of claims 83-85, wherein the cover comprises an indentation, and a protrusion of the switch is housed within the indentation.

87. The system of claim 86, wherein the indentation extends into the bulk of the cover a distance that is at least 10% of the thickness of the cover.

88. The system of any one of claims 83-87, wherein the cover comprises at least one accelerometer.

89. The system of claim 88, wherein the intensity of the light-emitting element can be adjusted by rotating the cover.

90. The system of any one of claims 83-89, wherein the cover comprises a power source.

91. The system of any one of claims 83-90, wherein the system comprises a hub electrically connected to the switch.

92. The system of claim 91, wherein the hub comprises a fitting configured to be mounted in a light socket.

93. The system of any one of claims 91-92, wherein the light-emitting element is part of the hub.

94. The system of any one of claims 91-93, wherein the hub is configured to receive at least one module via an interface.

95. The system of claim 94, wherein the hub is configured to provide power to the module.

96. The system of claim 95, wherein the hub is configured such that power is supplied to the light-emitting element independently of the power supplied to the module.

97. The system of any one of claims 91-96, wherein the module comprises at least one sensor, at least one audio device, at least one video device, and/or at least one security device receiving power from the switch.

98. The system of any one of claims 91-97, wherein the module does not contain a wireless networking device.

99. The system of any one of claims 91-98, wherein the module does not contain a power supply.

100. The system of any one of claims 83-99, wherein the cover is configured to prevent inadvertent operation of the wall-mounted switch while providing access for occasional operation of the wall-mounted switch.

101. The system of claim 100, wherein the cover comprises a opening through which the underlying wall-mounted switch can be accessed.

102. The system of any one of claims 83-101, wherein the wall-mounted switch is a toggle switch and/or a dimmer switch.

103. A method of retrofitting an electric switch, comprising:
fixing a state of a wall-mounted switch within an electric circuit to an on position; and
switching a light-emitting element receiving power from the electric circuit between an on state and an off state using a wireless switch in communication with the light-emitting element.

104. The method of claim 103, wherein the wireless switch at least partially encloses the wall-mounted switch.

105. The method of any one of claims 103-104, further comprising providing power to a hub electrically connected to the wall-mounted switch.

106. The method of claim 105, wherein the light-emitting element is part of the hub.

107. The method of claim 105, wherein the light-emitting element is detachable from the hub.

108. The method any one of claims 105-107, wherein the hub is electrically connected to the wall-mounted switch via a light socket.

109. The method of any one of claims 105-108, comprising switching the light-emitting element from an on state to an off state while continuing to provide power to the hub.

110. The method of any one of claims 105-109, wherein the hub is configured to receive at least one module via an interface.

111. The method of claim 110, wherein the hub is configured to provide power from the wall-mounted switch to the module.

112. The method of any one of claims 110-111, wherein the module comprises at least one sensor, at least one audio device, at least one video device, and/or at least one security device receiving power from the switch.

113. The method of any one of claims 110-112, wherein the module does not contain a wireless networking device.

114. The method of any one of claims 110-113, wherein the module does not contain a power supply.

115. The method of any one of claims 103-114, wherein the wireless switch functions via WiFi, ZigBee, Bluetooth, Z-Wave, ANT+, an infrared signal, an ISM radio band, and/or ultrasound.
